(19) United States
(12) Patent Application Publication
(10) Pub. No.: US 2008/0152214 A1
(43) Pub. Date: Jun. 26, 2008

(54) METHOD AND APPARATUS FOR GENERATING FILES AND METHOD AND APPARATUS FOR CONTROLLING STEREOGRAPHIC IMAGE DISPLAY

(75) Inventor: Youichi SAWACHI, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/962,202

(22) Filed: Dec. 21, 2007

(30) Foreign Application Priority Data
Dec. 22, 2006 (JP) 2006-345787

(51) Int. Cl. G06K 9/00

(52) U.S. Cl. 382/154; 382/106

(57) ABSTRACT

An apparatus for generating a file comprises a three-dimensional information generating means, a displacement information storage means and a file generating means. The three-dimensional information generating means generates three-dimensional information representing each point obtained by an imaging system by an inherent coordinate system inherent to the imaging system. The displacement information storage means stores displacement information representing displacement of an origin of an universal coordinate system from an origin of the inherent coordinate system, as information of the universal coordinate system common to a plurality of imaging systems. The file generating means generates a file of a predetermined format including three-dimensional information generated by the three-dimensional information generating means and the displacement information stored by the displacement information storage means.

### BACKGROUND OF THE INVENTION

1. Field of the Invention

This invention relates to a method and an apparatus for generating a file including three-dimensional information of a photography space (e.g., distance image) and a method and apparatus for controlling a stereographic image display.

2. Description of the Related Art

In the field of computer vision, the position of a point, which is visually recognized when a photography space is seen from a certain direction, is optically measured, whereby a three-dimensional shape of an object disposed in the photography space is recognized or the depth of the photography space is recognized. As a method of measurement, there have been known a stereo image method where the principle of trigonometry is used, a TOF (time of flight) method where a time from the projection of light to receipt of the reflected light is measured, and a light section method where pattern light is investigated when slit light is projected.

An image, in which the position of the visually recognizable point is represented by coordinates of a predetermined coordinate system and the values of the coordinates are recorded as pixel values, is generally called a “distance image” or a “depth image”. Such a distance image includes information on a spatial position recognized by humans due to the fact that humans see objects with both eyes. On the other hand, RGB data or a gradation image obtained by normal photography includes information on color and/or brightness recognized by a human when he or she sees an object. Accordingly, by combination of information obtained from the distance image and information obtained from the RGB data or the like, information substantially equivalent to that obtained by vision of a human when he or she sees the object can be recognized by a computer. This makes it feasible to reproduce a stereographic image of a photography space on a monitor, or to determine a three-dimensional object by a computer.

Since such a technique is useful in all industrial fields, many investigations have been promoted. However, the format used in recording the three-dimensional information of the photography space has not been sufficiently discussed, although several proposals have been made (see, for instance, FIG. 11 of U.S. Patent Application Publication No. 20020030675).

### SUMMARY OF THE INVENTION

In view of the foregoing observation and description, the primary object of the present invention is to provide a convenient format as a format for recording three-dimensional information of a photography space such as a distance image. The pixel values of the distance image differs according to the coordinate system. However, by which coordinate system the photography system is expressed is not standardized among manufacturers and systems. Accordingly, even when the same subject is photographed from the same position, the pixel values of the distance image differs according to the photography system that generates the distance image.

The difference in the coordinate systems gives rise to a problem when different photography systems are used in combination. For example, when a plurality of images are obtained by a plurality of photography systems and the images obtained by the respective photography systems are to be thereafter synthesized, a synthesized image may differ in its composition according to the photography systems that are used. Further, the difference in the coordinate systems gives rise to a problem when the photography systems are replaced. For example, a robot which is controlled on the basis of the values of distance images may not operate in the expected manner after replacement of the semiconductor image taking devices that function as the eyes of the robot.

In order to avoid such a problem, it is necessary to control the display or the operation taking into account the system or the origin of the coordinate system. However, the current imaging system such as the currently provided camera or sensors holds the information on the coordinate system as information invisible to the user. Accordingly, the user cannot control the processing taking into account the coordinate system. The object of the present invention is to overcome such an inconvenience so that the user can perform desired control and can obtain expected results by the control.

In accordance with a first aspect of the present invention, there is provided an apparatus for generating a file in which three-dimensional information is recorded comprising a three-dimensional information generating means, a displacement information storage means and a file generating means which will be described below.

The three-dimensional information is information representing each point taken by an imaging system by an inherent coordinate system inherent to the imaging system when the photography space is taken by the imaging system, and comprises, for example, a group of the values of coordinates (x, y, z) in an orthogonal coordinate system or a group of the values of coordinates (r, θ, Φ) in a polar coordinate system. Information on the color or the gradation of the photography space may be either included or not included. The three-dimensional information generating means is a means for generating such three-dimensional information. The three-dimensional information may be generated by means of the stereo image method or the TOF method described above. The inherent coordinate system inherent to the imaging system is a coordinate system separately defined inside the system provided with the imaging system, and is normally unchanged. When the characteristics of the imaging system are variable, for instance, as in the case when the imaging system is provided with a zoom lens where the focal length is variable, the inherent coordinate system is to be defined according to the characteristics of the imaging system.

The displacement information storage means is composed of memories, hard discs and the like and stores displacement information representing displacement of an origin of a universal coordinate system from an origin of the inherent coordinate system as information of the universal coordinate system common to a plurality of imaging systems. The universal coordinate system is a coordinate system defined independently of the manufacturer and the model of the imaging system. The universal coordinate system is defined to be recognized by a user to be a coordinate system common to a plurality of imaging systems. The universal coordinate system may be any so long as the user can recognize it, although an orthogonal system or a polar coordinate system is preferred. When a universal coordinate system is defined, it is preferred that the origin be set at a predetermined characteristic point on a member that constitutes the imaging system or a member formed integrally with the imaging system. For example, when a site which can be recognized through an appearance on a member which can be recognized through its appearance is marked with a mark and the mark is taken as the origin of the universal coordinate system, the origin of the universal coordinate system can be easily recognized by the user. Since the mark has to be recognized only when necessary, it is possible to display the mark according to a control operation of a monitor formed integrally with the imaging system.

The displacement information is information representing a displacement of the inherent coordinate system and the universal coordinate system from each other and is, for example, stored as a displacement vector where the origin of the inherent coordinate system is taken as the starting point and the origin of the displacement information storage means universal coordinate system is taken as the terminating point. The displacement information storage means may store displacement information on a plurality of universal coordinate systems. When the displacement information storage means stores displacement information on a plurality of universal coordinate systems, the user can select one of the universal coordinate systems and the displacement information thereof, which fulfills the user's purpose and improves the user's convenience.

The file generating means generates a file of a predetermined format including three-dimensional information generated by the three-dimensional information generating means and the displacement information stored by the displacement information storage means. When the displacement information storage means stores displacement information on a plurality of universal coordinate systems, the file generating means generates a file of a predetermined format including three-dimensional information generated by the three-dimensional information generating means and an identifier indicating one of a plurality of pieces of the displacement information designated by a control operation. Further, the displacement information storage means may record information regarding the type of the universal coordinate system in the same file.

The apparatus for generating a file in accordance with the present invention may be unnecessary when the focal length of the lens is unchanged. However, when the imaging system is provided with a zoom lens where the focal length is variable, since the inherent coordinate system is defined according to the characteristics of the imaging system, it is necessary to reset the displacement information stored by the displacement information storage means.

In accordance with a second aspect of the present invention, there is provided a method for generating a file in which three-dimensional information is recorded. In this method, in the imaging system of the image taking apparatus, displacement information representing displacement of an origin of an universal coordinate system from an origin of the inherent coordinate system inherent to the imaging system as information of the universal coordinate system common to a plurality of imaging systems is stored in advance and three-dimensional information representing each point taken by an imaging system by a inherent coordinate system inherent to the imaging system when the photography space is taken by the imaging system. Then a file of a predetermined format including the three-dimensional information and the displacement information described above is generated.

In accordance with the method and apparatus of the present invention, when the three-dimensional information of a photography space is recorded in a file, an inherent coordinate system used in representing the three-dimensional information and displacement information representing the displacement from the universal coordinate system which can be recognized by the user are recorded together therewith. Accordingly, the coordinate system of the three-dimensional information can be subsequently changed by the use of the displacement information. Thereby, the utility in image recognition using three dimensional information and the user who controls the display by the three-dimensional information can be improved. Further, the various problems inherent to the conventional method where three-dimensional information is represented by different coordinate systems can be overcome.

The display controlling apparatus of the third aspect of the present invention will be described hereinbelow. The display controlling apparatus of the present invention is for controlling display of three-dimensional images, and comprises a file obtaining means, a three-dimensional information converting means, an image composing means and an output control means, which will be described below.

The file obtaining means takes in an image file including an image where a photography space is taken, three-dimensional information representing the photography space by the inherent coordinate system inherent to the imaging system, displacement information representing displacement of an origin of a universal coordinate system common to a plurality of coordinate systems from an origin of the inherent coordinate system. The three-dimensional information, inherent coordinate system, universal coordinate system and the displacement information are the same as those described for the file generating system.

The three-dimensional information converting means displaces the three-dimensional information in the image file taken in by the file obtaining means according to the displacement information in the image file, thereby converting three-dimensional information represented by the inherent coordinate system to that represented by the universal coordinate system. The image composing means composes a parallax image for display by correcting an image in the image file taken in by the file obtaining means on the basis of the three-dimensional information after conversion by the three-dimensional information converting means. The output control means outputs the parallax image for display by the image composing means to a display device. The image composing means may be further provided with a function of composing a synthesized parallax image by synthesizing a plurality of sets of parallax images for display composed by the image composing means.

The display controlling method of the fourth aspect of the present invention is for controlling display of a three-dimensional image, and in the display controlling method of the present invention, an image file including a parallax image where a photography space is taken, three-dimensional information representing the photography space by the inherent coordinate system inherent to the imaging system, displacement information representing displacement of an origin of a universal coordinate system common to a plurality of coordinate systems from an origin of the inherent coordinate system is first obtained. Then, three-dimensional information represented by the inherent coordinate system is converted to that represented by the universal coordinate system by displacing the three-dimensional information in the image file on the basis of the displacement information in the image file. Then, a parallax image for display is composed by correcting the image in the image file on the basis of the converted three-dimensional information and the composed parallax image is output to the display device.

In accordance with the display controlling method and apparatus of the present invention, since the parallax image for display is represented by the universal coordinate system, the stereographic image of an image composition can be displayed by employing the same universal coordinate system irrespective of the image taking apparatuses even if different photography systems are used in combination or the photography systems are replaced.

### BRIEF DESCRIPTION OF THE DRAWINGS

FIG. 1A is a perspective view as seen from front showing an appearance of a stereo camera in accordance with an embodiment of the file generating apparatus of the present invention,

FIG. 1B is a perspective view as seen from rear showing an appearance of the stereo camera in accordance with the embodiment of the file generating apparatus of the present invention,

FIG. 2 is a block diagram showing inside structure of the stereo camera,

FIG. 3 is a view showing an example of the photography space,

FIG. 4 is a view showing an example of the parallax image (RGB data),

FIG. 5 is a view showing an example of the inherent coordinate system,

FIG. 6 is a view showing an example of another structure of the camera,

FIG. 7 is a view showing an appearance of an example of the camera having another structure,

FIG. 8 is a view showing the format of the image file,

FIG. 9 is a view showing a part of the header of the image file,

FIGS. 10 through 14 are views showing problems of conventional methods,

FIG. 15 is a view showing an example of the universal coordinate system,

FIG. 16 is a view showing an example of the origin recognizable through an appearance,

FIG. 17 is a view showing another example of the origin recognizable through an appearance,

FIG. 18 is a view showing another prospect of the origin of the universal coordinate system,

FIG. 19 is a view showing a detailed format of the area h8 where the displacement information is set,

FIG. 20 is a view briefly showing a stereographic image display system,

FIG. 21 is a view showing an example of the display control apparatus,

FIG. 22 is a flowchart showing an example of the processing of the distance image converting section,

FIG. 23 is a flowchart showing an example of the processing of the image composing section,

FIG. 24 is a flowchart showing an example of the display control processing when taking in a plurality of image files,

FIG. 25 is a view showing an example of the relationship between the camera, photography space, and the universal coordinate system when the main image is obtained,

FIG. 26 is a view showing an example of the display of only the main image,

FIG. 27 is a view showing an example of the relationship between the camera, photography space, and the universal coordinate system when the sub-image is obtained,

FIG. 28 is a view showing an example of the display of only the sub-image,

FIG. 29 is a flowchart showing an example of the processing of the synthetic parallax image,

FIG. 30 is a view for describing a sub-image disposing area,

FIG. 31 is a view showing an example of the display of the synthetic parallax image,

FIG. 32 is a view showing an example of the display of the partly enlarged image of the main image,

FIG. 33 is a view showing an example of the display in only the sub-image disposing area,

FIG. 34 is a view showing an example of the special display in only the sub-image disposing area,

FIG. 35 is a view showing an example of the correction of the partly enlarged image for the special display,

FIG. 36 is a view showing the format of the synthetic parallax image file, and

FIG. 37 is a view showing a part of the header of the synthetic parallax image file.

### PREFERRED EMBODIMENT OF THE INVENTION

A stereo camera in accordance with an embodiment of the file generating apparatus of the present invention will be described with reference to the drawings, hereinbelow.

### [Apparatus]

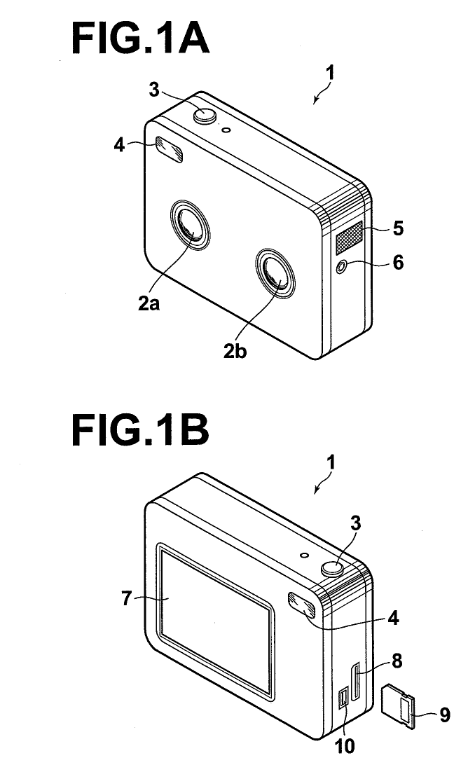

FIGS. 1A and 1B are perspective views respectively as seen from the front and the rear showing the appearance of a stereo camera in accordance with an embodiment of the file generating apparatus of the present invention. The stereo camera 1 is of a type where the depth of a photography space is measured by a stereo method and is provided with a pair of imaging lenses 2a and 2b. The stereo camera 1 is further provided with a shutter release button 3, a viewfinder 4, a speaker 5, a microphone 6, a liquid crystal monitor 7, a card slot 8 for setting a memory card 9, an external connection interface 10 for connecting a cable, and other control buttons or dials (not shown) as the common digital cameras.

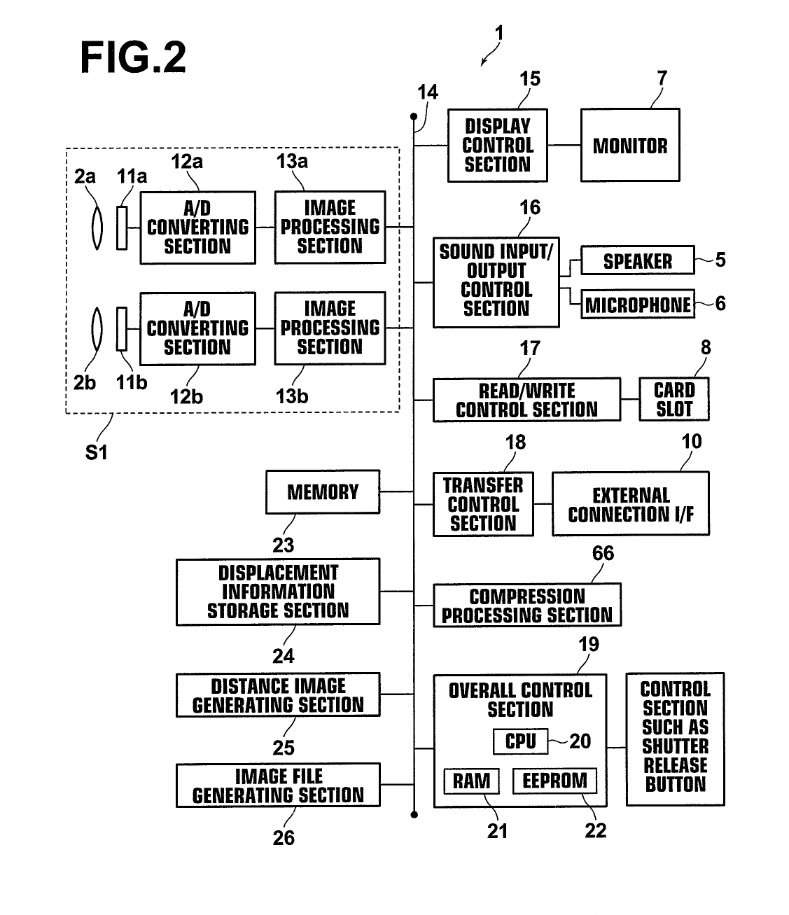

FIG. 2 is a block diagram showing inside structure of the stereo camera 1. As shown in FIG. 2, the stereo camera 1 is provided with an imaging system comprising the imaging lenses 2a and 2b, a diaphragm (not shown), a pair of CCD's 11a and 11b and mechanisms (motor, control circuit and the like; not shown) for controlling the position or orientation of the lenses, opening and closure of the diaphragm and the electric charge/discharge condition of the CCD's and is further provided with a pair of A/D converting sections 12a and 12b as means for converting the signal obtained by the imaging system to digital data. The baseline length and the angle of convergence of the imaging system can be varied, by changing the position or orientation of the lenses 2a and 2b (including the CCD and the like) by driving the motor.

The stereo camera 1 is further provided with a display control section 15 for controlling display output to a monitor 7, a sound input/output control section 16 for controlling output to the speaker 5 and input from the microphone 6, a read/write control section 17 for controlling recording of data in a memory card 9 loaded in the card slot 8 and reading of data from a memory card 9 loaded in the card slot 8, and a transfer control section 18 for controlling the input/output between instruments connected to the external connection interface 10. These control sections are mounted respectively as a dedicated circuit or a driver program.

Further, the stereo camera 1 is provided with a memory 23 such as a SDRAM and an overall control section 19 which controls the action of the overall camera. The overall control section 19 comprises a RAM 21 in which a control program has been recorded, an EEPROM in which various default values for control have been recorded, and a CPU 20 for executing the control program, and in response to receipt of input from the control section such as the shutter release button 3, transfers instruction signals to the corresponding parts directly or by way of the system bus 14. The corresponding parts execute their processes while exchanging the processed data by way of the memory 23.

In addition to the above described functions, image processing sections 13a and 13b, a compression processing section 66, a displacement information storage section 24, a distance image generating section 25, and an image file generating section 26 are connected to the system bus 14. In this embodiment, the displacement information storage section 24 is mounted as an EEPROM which stores data to be described later, and the image processing sections 13a and 13b, compression processing section 66, distance image generating section 25, and the image file generating section 26 are mounted as dedicated processors, respectively. However, the form of mounting of these processing sections is not limited. For example, they may be mounted as one processor which is provided with the above described functions or may be mounted as a program stored in the RAM 21 of the overall control section 19.

The operation of the stereo camera 1 will be described hereinbelow, while remarking the processing in the image processing sections 13a and 13b, the displacement information storage section 24, distance image generating section 25, and the image file generating section 26.

### [Photography]

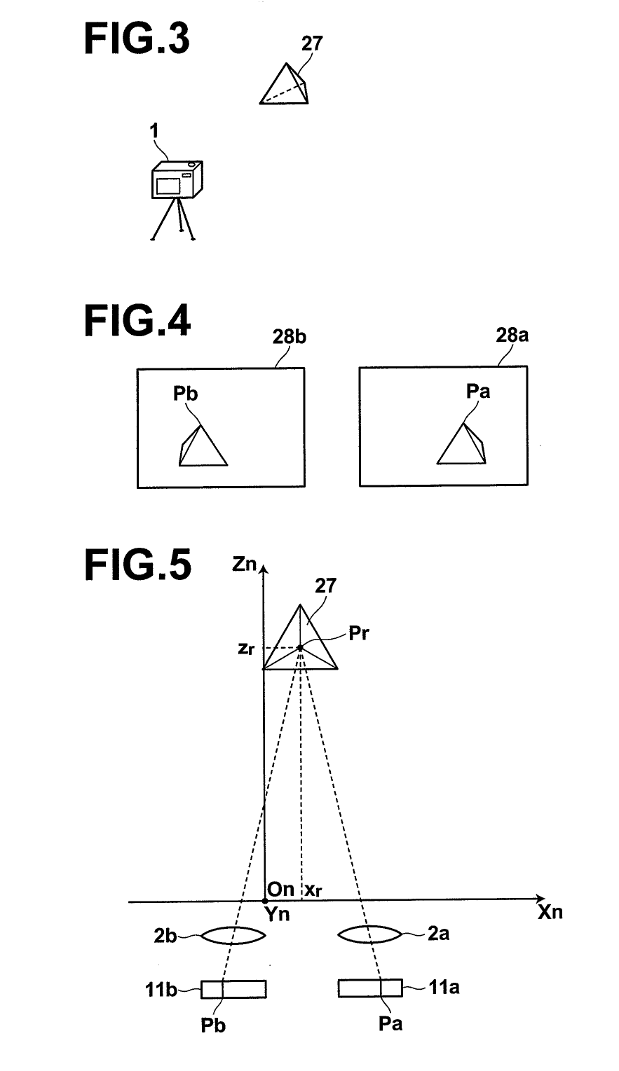

When a operation for photography, such as depression of the shutter release button 3 is carried out, the operation is detected by the overall control section 19. The overall control section 19 outputs the various instruction signals to the imaging system. Thereby, video signals representing a photography space are input into the A/D converting sections 12a and 12b from the imaging system and a pair of pieces of image data are output respectively from. In this particular embodiment, each piece of image data is in the form of RGB data. The pieces of RGB data respectively supplied from the A/D converting sections 12a and 12b are stored in the memory 23 by the image processing sections 13a and 13b. For example, when an image of an object 27 shaped like a pyramid as shown in FIG. 3 is imaged, RGB data 28a obtained through the imaging lens 2a and RGB data 28b obtained through the imaging lens 2b are stored in the memory 23 as shown in FIG. 4.

Then, the image processing sections 13a and 13b carries out RGB-YCC conversion on the pieces of RGB data respectively supplied from the A/D converting sections 12a and 12b. Then, the pieces of the YCC data obtained by the RGB-YCC conversion are stored in the memory 23. Thereafter the pieces of the YCC data are read out by the compression processing section 66 and are stored again in the memory 23 after compression. With this structure, two pieces of YCC data generated by converting and compressing two pieces of RGB data respectively obtained through the imaging lens 2a and obtained through the imaging lens 2b at the same moment are stored in the memory 23. It is possible to compress the RGB data as it is by the compression processing section 66 without RGB-YCC conversion. In this case, in the processes to be described below, YCC data should be read as RGB data.

### [Generation of the Distance Image]

The distance image generating section 25 reads out two pieces of RGB data obtained simultaneously through different lenses. Then, pixels forming two pieces of RGB data are linked by a pattern matching process. For example, in the case of the example shown in FIG. 4, the pixel Pa in the RGB data 28a is linked with the pixel Pb in the RGB data 28b. The other pixels forming the RGB data 28a and 28b are similarly linked with each other.

Then, the distance image generating section 25 carries out calculations based on trigonometry by the use of information on the above links among the pixels, the baseline length and the angle of convergence, and obtains the values of the spatial coordinates for all of the points taken by the camera in the photography space. This calculation is carried out on an inherent coordinate system and the positions of each point are represented by the values of the inherent coordinate system. FIG. 5 shows an inherent coordinate system in the form of orthogonal coordinate system, where the right and left direction of the stereo camera 1 is taken as the Xn axis, the up and down direction of the stereo camera 1 is taken as the Yn axis (not shown) and the direction from the rear to the front of the stereo camera 1 is taken as the Zn axis, disposed in the photography space shown in FIG. 3. In the illustrated example, the origin of the inherent coordinate system is slightly shifted toward the imaging lens 2b from the center of the camera in the front side of the camera. The position of the point Pr in the photography space represented by the pixel Pa in the RGB data 28a and the pixel Pb in the RGB data 28b is represented by (xr, yr, zr), although yr is not shown.

When the values (x, y, z) of the coordinates are determined for all of the points taken by the camera through the repeated calculation, the distance image generating section 25 records the values (x, y, z) of the coordinates for each point as the distance image of the photography space. For example, the x-value, y-value and z-value of each point are recorded respectively as 8 bit pixel data. Then a generated distance image is stored in the memory 23 together with the RGB data and the YCC data. The distance image may be compressed by the compression processing section 66 as the YCC data.

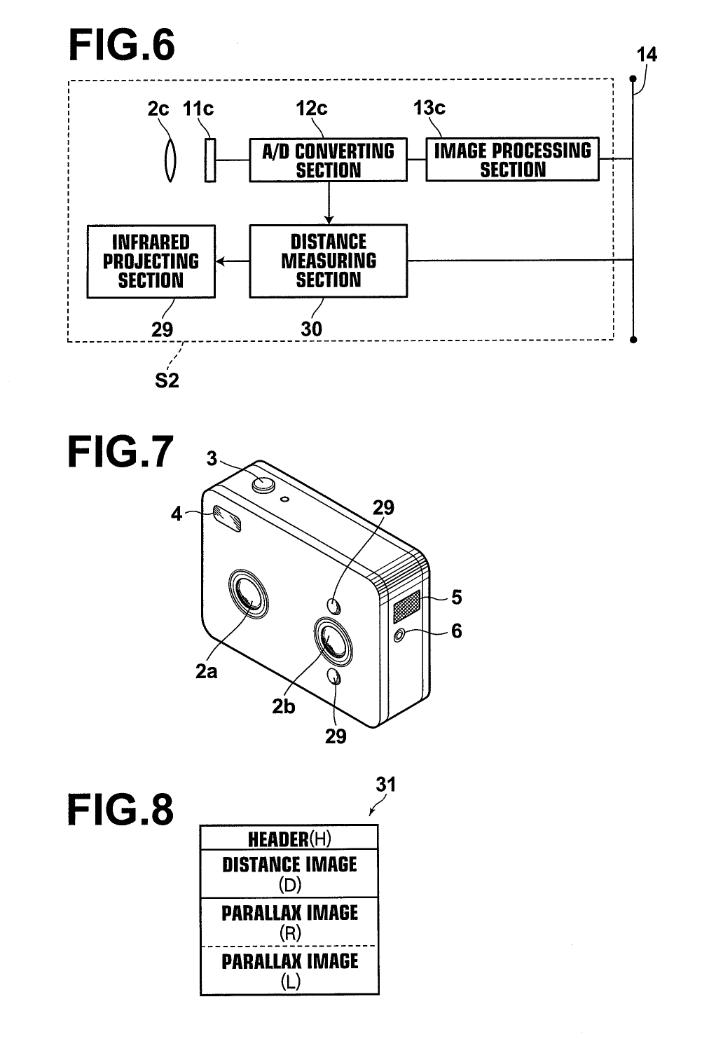

Since the stereo camera 1 is a camera which is configured to obtain the positions of points which can be viewed when viewing the photography space in one direction by a stereo method, the values of each pixel of the distance image are the values of (x, y, z) coordinates. However, in the case of a camera, in which a method other than a stereo method is employed, other values are sometimes recorded as the values of the distance image. As a camera of a type different from the stereo camera 1, for instance, that in which the structure S2 circumscribed by the broken line in FIG. 6 is substituted for the structure S1 circumscribed by the broken line in FIG. 2 is conceivable. The structure S2 comprises an imaging lens 2c, a CCD 11c, an A/D converting section 12c, an image processing section 13c, an infrared ray projecting section 29 and a distance measuring section 30. In the structure S2, the infrared ray projecting section 29 projects amplitude-modulated infrared rays. The distance measuring section 30 controls the timing of projection and the frequency of amplitude-modulation. The projected infrared rays are reflected at various parts inside the photography space and the reflected light is received by the imaging lens 2c and the CCD 11c. The A/D converting section 12c supplies signals representing the reflected light to the distance measuring section 30. The distance measuring section 30 calculates the distance and direction to all of the points which can be imaged by the camera on the basis of the instructed timing of infrared ray projection, the timing of the reflected light receipt, and the shift in phase of the projected light and the reflected light (that is, by the TOF method). That is, the values of the coordinates when a polar coordinate system is defined in the photography space are obtained. In the case of a camera provided with the structure S2, the distance image generating section 25 generates a distance image having pixel values in the form of coordinate values (r,θ,φ) in the polar coordinate system.

A structure of a camera in which the camera is provided with both the structure S1 shown in FIG. 2 and the structure S2 shown in FIG. 6 and the stereo method and the TOF method are switched with each other is conceivable. FIG. 7 shows an appearance of a camera which is provided with both of the structures S1 and S2. The imaging lens 2b functions as the imaging lens 2b of FIG. 2 and at the same time as the imaging lens 2c of FIG. 6.

Although various structures for the camera for obtaining the three-dimensional information of a photography space are conceivable as described above, and the kind and the accuracy of the three-dimensional information depend upon the technique employed, any structure for the camera and any kind of the values of coordinates to be recorded as the distance image may be employed, as long as the three dimensional information related to the photography space is obtained.

### [Generation of Image Files]

Generation of image files by the image file generating section 26 will be described hereinbelow. The image file generating section 26 generates a file whose format is as shown in FIG. 8, that is, an image file 31 including a file header H, a distance image D and a pair of pieces of YCC data (parallax images R and L). Information to be set in the file header is read out from the memories in the camera or taken in from information selected or input by the user in the setting screen displayed on the monitor 7. Parallax images R and L and a distance image D are read out from the memory 23.

Although a pair of pieces of YCC data are stored in the image file as parallax images R and L in this embodiment, it is possible to store only the YCC data generated from an image obtained through one of the imaging lenses. In the case of the camera having the structure described above with reference to FIG. 6, a single piece of YCC data is stored in the image file since the camera has only one imaging lens.

The image file generating section 26 temporarily stores the generated image file in the memory 23. The image file stored in the memory 23 is transferred to the read/write control section 17 under the control of the overall control section 19, and is recorded on the memory card 9 or the like by way of the card slot 8. Further, the image file stored in the memory 23 is transferred to the transfer control section 18 also under the control of the overall control section 19, and is transferred to other apparatuses by way of the external connection interface 10. Otherwise, the image file is transferred to the display control section 15 and is displayed on the monitor 7.

The format of the image file 31 is as described in detail below. The image file 31 comprises a file header H, a distance image D and parallax images R and L as described above. In the file header H, information on the offset between the top of the image file and the distance image and information on the offsets between the top of the image file and the parallax images R and L are included in addition to information on the file type and the file size. Accordingly, when the format of the header information is recognized from the information on the file type recorded on the top of the file and the information on the offsets in the header information is referred to, the distance image D and/or the parallax images R and L can be read out.

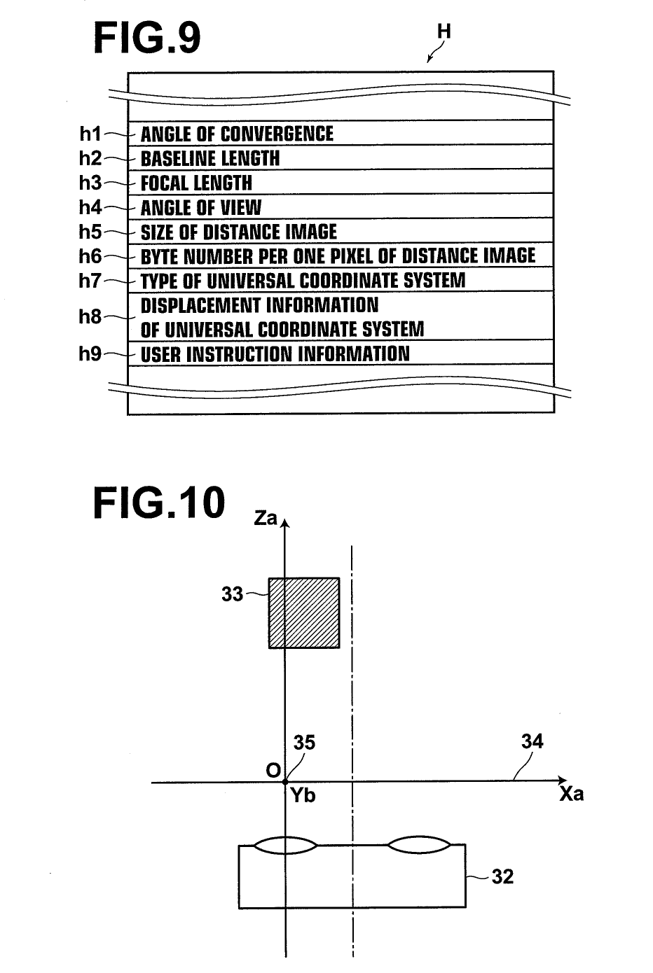

Further, as shown in FIG. 9, areas for setting information on the distance image are provided in the file header H. These areas include: an area h1 where the angle of convergence when the image is taken is set, an area h2 where the baseline length is set, an area h3 where the focal length is set, an area h4 where the angle of view is set, an area h5 where the size of the distance image (the number of pixels in the longitudinal and transverse directions) is set, and an area h6 where the number of the bytes allotted to each pixel of the distance image is set. The area h3 is defined so that when a pair of imaging lenses is provided as in the stereo camera 1, the focal lengths can be set for the respective imaging lenses. In the area h4, the angle of view can be set for both the horizontal and vertical directions of each imaging lens.

The angle of convergence, the baseline length, the focal length, the angle of view, the size of the distance image, and the number of the bytes per one pixel have been determined to be inherent to the imaging system or are determined when the imaging system is adjusted. Whether these elements are inherent to the imaging system or depend upon the adjustment of the imaging system depends upon the specification of the camera. For example, in the case of a camera in which the angle of convergence is fixed, the angle of convergence is a value inherent to the imaging system, and in the case of a camera in which the angle of convergence is variable, the angle of convergence is a variable value.

The values inherent to the imaging system have been stored at a predetermined area in a predetermined memory in the stereo camera 1 (the EEPROM 22 in the overall control section 19, the memory 23, or another memory, not shown). The values determined by adjustment are stored in a predetermined memory by a control section which carried out the adjustment at the time when the adjustment is completed. The image file 26 reads out the values which are thus stored, and sets the read-out values to the respective above areas h1 to h6 of the file header.

There are further areas for setting information on the distance image provided in the file header H. These areas include: an area h7 for setting the type of the universal coordinate system (an orthogonal coordinate system or a polar coordinate system), an area h8 for setting information on the displacement of the universal coordinate system and an area h9 for setting one universal coordinate system which has been specified by the user. The information on the universal coordinate system set in the areas h7 to h9 will be described, while pointing out the problem inherent to the conventional method or apparatus which does not adopt the concept of the universal coordinate system.

### [Universal Coordinate System]

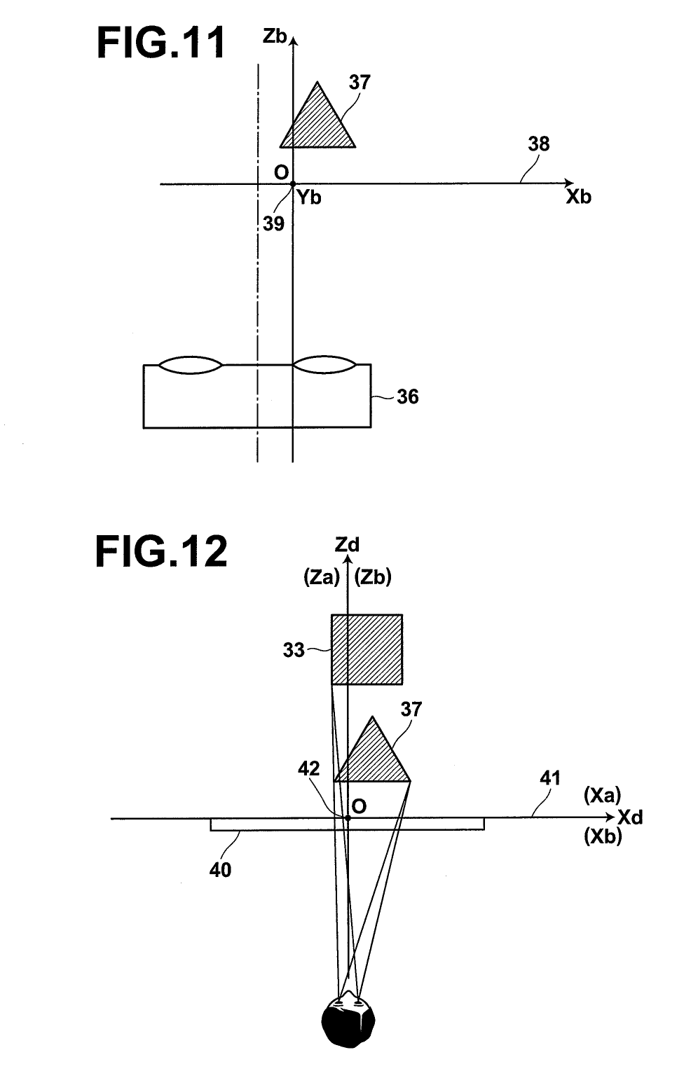

FIG. 10 shows the relationship among a first camera 32 provided with a function of obtaining three-dimensional information (such as a distance image), a photography space in which a cubic object 33 is disposed, the inherent coordinate system 34 of the first camera 32, and the origin 35 of the inherent coordinate system 34. FIG. 11 shows the relationship among a second camera 36 provided with a function of obtaining three-dimensional information, a photography space in which a triangular object 37 is disposed, the inherent coordinate system 38 of the second camera 36, and the origin 39 of the inherent coordinate system 38. In FIGS. 10 and 11, the chain lines are center lines between the left half and the right half of the camera 32 or 36. In the photography space shown in FIG. 10, the object 33 is disposed on the left side of the center line of the camera 32, while in the photography space shown in FIG. 11, the object 37 is disposed on the right side of the center line of the camera 36. As is clear from the comparison of FIGS. 10 and 11, the first and second cameras 32 and 36 largely deviate from each other in the origins of their inherent coordinate systems. In FIGS. 10 and 11, the Y-axes of the inherent coordinate systems 34 and 38 are perpendicular to the paper surface and overlap the origins 35 and 39.

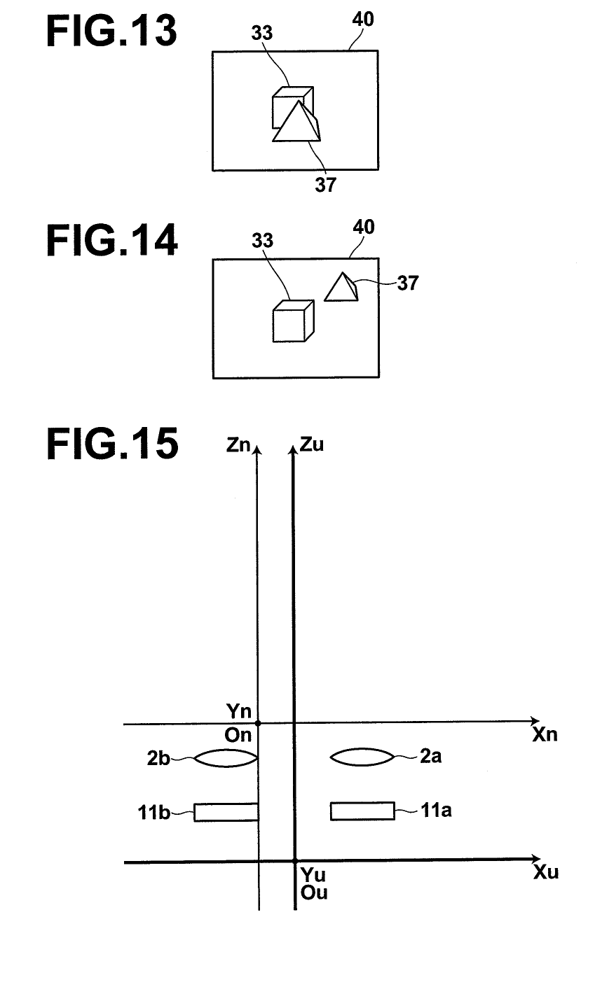

FIG. 12 is a view showing the relationship among the coordinate system 41 for display, and the objects 33 and 37 when photography is first carried out with the relative position shown in FIG. 10, photography is next carried out with the relative position shown in FIG. 11, and the two pairs of parallax images obtained through the two photography operations are synthesized for display on the stereographic monitor 40. In the conventional technique, the values of each pixel of the distance image obtained on the inherent coordinate system are used as they are as the values representing the feeling of depth of the display. That is, the relative position between the origin 35 and the object 33 in FIG. 10 is held as it is, as the relative position between the origin 42 and the object 33 in the coordinate system 41 for display. Similarly, the relative position between the origin 39 and the object 37 in FIG. 11 is also held as it is, as the relative position between the origin 42 and the object 37 in the coordinate system 41 for display. As a result, an image where the object 33 is disposed behind the object 37 is displayed on the stereographic monitor 40 as shown in FIG. 13.

On the other hand, assume that the first camera 32 is also used when photographing the photography space including the object 37 as in the photograph of the photography space including the object 33 in the relative position shown in FIG. 11. In this case, in the synthesized stereographic image, the objects 33 and 37 are displayed apart from each other as shown in FIG. 14. This is because the object 33 is disposed on the left side of the center line of the camera, the object 37 is disposed on the right side of the center line of the camera, and the Z-axis is disposed on the left side of the center line of the camera.

As can be understood from the comparison of FIGS. 13 and 14, in accordance with the conventional technique, when a synthetic stereographic image is to be generated from a plurality of stereographic images, the result obtained from the synthesis differs depending on the camera used during the photography thereof. For similar reasons, stabilized recognition cannot be realized so long as the same imaging system is not continuously used in accordance with the conventional technique, when the shape or the position of an object is recognized to carry out a control operation.

These problems inherent to the conventional technique can be overcome by adopting the concept of the universal coordinate system. The universal coordinate system is a coordinate system defined in the photography space as the inherent coordinate system. However, while the inherent coordinate system is defined by the individual cameras and is invisible to the user, the universal coordinate system is defined to be recognizable to the user.

In FIG. 15, an example of the universal coordinate system overlaps the inherent coordinate system of the stereo camera 1 shown in FIG. 5. In this example, the universal coordinate system is a three-dimensional orthogonal coordinate system with its Xu axis directed rightward from the left, its Yu axis directed upward from below and its Zu axis extending toward the photography space perpendicular to both the Xu axis and the Yu axis. Further, in this example, the origin Ou of the universal coordinate system is at the center of the rear surface of the stereo camera 1.

When generating an image file, the displacement of the origin when the coordinate system is switched from the inherent coordinate system to the universal coordinate system, or the shift between the origin On of the inherent coordinate system and the origin Ou of the universal coordinate system is recorded. In other words, the displacement vector, whose starting point is on the origin On of the inherent coordinate system and whose terminating is on the origin Ou of the universal coordinate system is recorded. For example, assuming that the position of the origin Ou of the universal coordinate system is represented by values of coordinates (vector) (xc, yc, zc) in the inherent coordinate system, the values of xc, yc and zc are stored in the file header as information on the displacement of the universal coordinate system.

When the information on the displacement of the universal coordinate system is recorded in the header of the image file, the processing can be carried out after each pixel value in the distance image is converted from the values of the coordinates in the inherent coordinate system to the values of the coordinates in the universal coordinate system when carrying out a process on the basis of the distance image such as the stereographic image process or the shape recognition process.

The problems inherent to the conventional technique described above with reference to FIGS. 10 to 14 can be overcome by converting each pixel value in the distance image obtained by the first imaging system from the values of the coordinates in the inherent coordinate system to the values of the coordinates in the universal coordinate system, converting each pixel value in the distance image obtained by the second imaging system from the values of the coordinates in the inherent coordinate system to the values of the coordinates in the universal coordinate system, and carrying out synthesis of images by the use of the distance image after the conversion. Similarly, even if the cameras are changed during the course of photography, which is continuously performed, the fact that the cameras were changed cannot adversely affect the previously performed photography by converting each pixel value in the distance images obtained by the cameras before and after changing cameras.

Further, all of the problems generated due to the fact that the coordinate system is inherent to the camera can be overcome by adopting the concept of the universal coordinate system.

### [Setting of the Universal Coordinate System Information]

Although only one universal coordinate system is defined in the above description of the universal coordinate system for the purpose of ease in understanding, a plurality of the coordinate systems which can be selected as the universal coordinate systems, that is, a plurality of the prospective universal coordinate systems, are defined in the stereo camera 1 of this embodiment. The displacement information on all of the coordinate systems which the user can select and information for identifying the displacement information the user has selected are recorded in the file header H.

The type of the universal coordinate system set in the area h7 will be described first. The specification of the type of the universal coordinate system is received from the user in a setting screen displayed on the monitor 7 by the overall control section 19 before photography. Data input in the selection screen is once stored in the memory 24 in FIG. 2. The image file generating section 26 reads out the data from the displacement information memory 24 when generating an image file and records it in the area h7. In this particular embodiment, one of “0”, “1” and “2” is recorded in the area h7, wherein “1” represents that the universal coordinate system is a three-dimensional orthogonal coordinate system, “2” represents that the universal coordinate system is a polar coordinate system, and “0” represents that the universal coordinate system is unknown, that is, the user has input no specification about the type of the coordinate system.

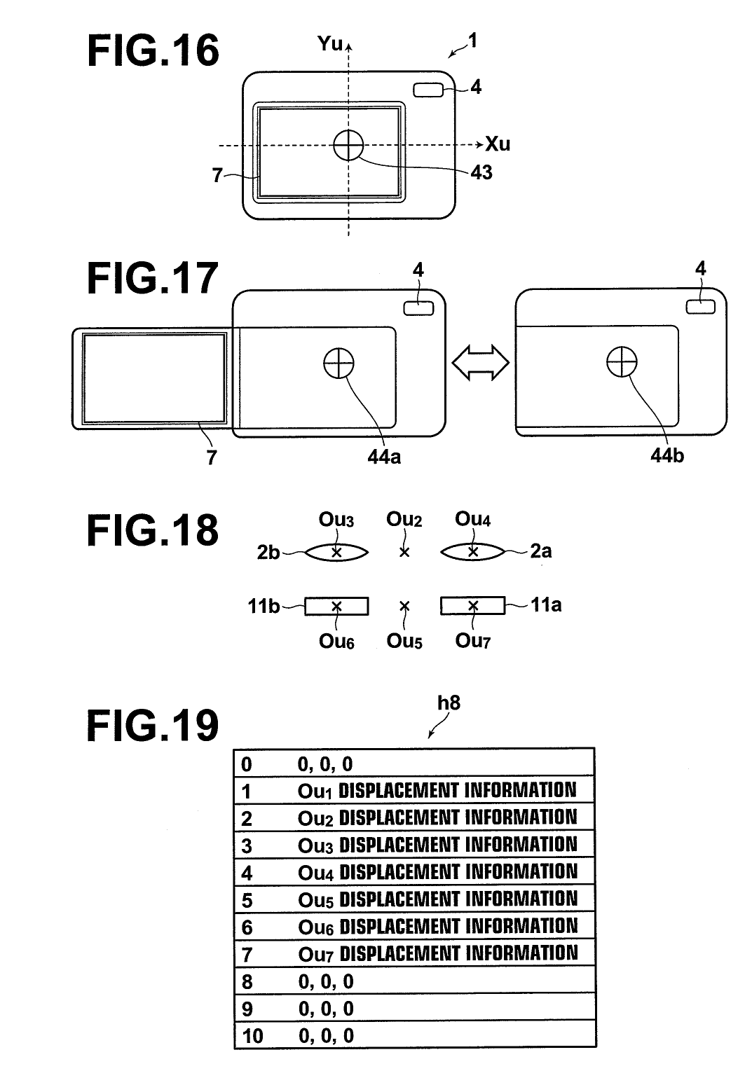

The displacement information of the universal coordinate system to be set in the area h8 will be described, hereinbelow. In the stereo camera 1 of this embodiment, a total of eight points, including the center Ou1 of the rear surface of the camera body described above in conjunction with the universal coordinate system and the origin Ou0 of the inherent coordinate system, are defined as points which can be an origin of the universal coordinate system. The center Ou1 of the rear surface of the camera body described above can be recognized from the outer appearance of the camera, by displaying a reference mark 43 in the monitor 7 as shown in FIG. 16 by way of example. The reference mark 43 is only displayed when the user carries out a predetermined operation. When a camera is of a type in which the monitor is opened and closed and the state of the rear surface of the camera differs according to whether the monitor is used as shown in FIG. 17, reference marks 44a and 44b may be provided on an outer shell of the camera by printing or processing.

When a reference mark is on a member which can be recognized from the outer appearance of the camera and at a position which can be recognized from the outer appearance, for instance, when the cameras are changed, the new camera can be positioned with respect to the old camera so that the reference mark on the new camera is in the same position as that on the old camera.

FIG. 18 is a view showing other points defined to be prospective origins of the universal coordinate system. As shown in FIG. 18, the center Ou2 between the imaging lenses 2a and 2b, the centers Ou3 and Ou4 of the respective imaging lenses 2a and 2b, the center between the CCD's 11a and 11b and the centers Ou6 and Ou7 of the respective CCD's 11a and 11b are defined to be prospective origins of the universal coordinate system. Although these points are not recognizable from the outward appearance of the camera, even a point which is inside the camera body and is normally invisible can be an origin of the universal coordinate system, as long as it has a specific characteristic, such as the center or end of a predetermined member.

The coordinate values in the inherent coordinate system of these 8 points Ou0 to Ou7, that is, the displacement information, is stored in the displacement information storage section 24 upon manufacture of the camera. However, when the imaging system is provided with a zoom lens, where the focal length is variable, the displacement information stored in the displacement information storage section 24 is reset according to change of the focal length since the inherent coordinate system is re-defined according to the characteristics of the coordinate system. In this embodiment, the overall control section 19 functions as a displacement information setting section when a zoom operation by the user is received. The overall control section 19 detects the focal length set in response to the zoom operation and rewrites the displacement information which has been stored in the displacement information storage section 24 according to the detected focal length. Link of the focal length and the origin of the inherent coordinate system has been registered in a RAM 21 or the like in advance. By referring to the link, the origin of the inherent coordinate system corresponding to the detected focal length is obtained, and the displacement on the basis of the origin is recalculated, whereby the displacement information can be reset. The image file generating section 26 reads out the displacement information thus stored or reset from the displacement information storage section 24 and stores it in the area h8 of the file header.

FIG. 19 shows a detailed format of the area h8 in which the displacement information is set. The area h8 comprises a plurality of areas where the identifier and the displacement information are stored linked with each other. The identifier comprises a figure, an alphabetical letter, or another symbol. FIG. 19 shows a case where serial numbers starting from 0 are employed as identifiers by way of example. It is preferred that where the displacement information of each point is set be determined on the basis of a common rule determined in advance. In this embodiment, the displacement information of the point Ou0, that is, (0, 0, 0), is recorded linked with identifier 0, the displacement information of the point Ou1 is recorded linked with identifier 1, or as the number of identifiers are smaller, the number of the points Ou2 to Ou7 (shown in FIG. 18) linked with the identifiers becomes smaller.

The area h8 is provided with areas where cameras of a type having only one imaging lens and/or CCD sets the displacement information in addition to the areas where the stereo camera 1 sets the displacement information. They are areas where the displacement information of the center of the only one imaging lens (the area corresponding to the identifier 8) and the displacement information of the center of the only one CCD (the area corresponding to the identifier 9) are set. Further, a spare area (the area corresponding to the identifier 10) is prepared in the area h8. Values of 0, 0, 0 are set in unused areas as shown in FIG. 19. User specified information to be set in area 9 in FIG. 9 will be described, hereinbelow. The user specified information is received in the setting screen that the overall control section 19 displays on the monitor 7 before carrying out the photographing as the type of the coordinate system. Data input in the selection screen is temporarily stored in the information storage section 24 of FIG. 2 and is read out therefrom by the image file generating section 26 to be set in the area h9. The value “0” or the value of the identifier representing one of the displacement information which the user has selected is set in the area h9. The value “0” means that the user has not selected the displacement information.

As can be understood from the description above, when the file header is structured so that a plurality of pieces of displacement information of coordinate systems can be stored and an identifier and a type of the coordinate system instructed by the user can be stored, the user can select the most convenient universal coordinate system for the processing using the image file, and can ensure the convenience absent from the conventional technique. Further, if there are problems with the universal coordinate system, one of the other coordinate systems can be re-selected. Therefore, the object can be more easily accomplished by using the universal coordinate system according to the object.

### [Display Apparatus]

The image file output from the stereo camera 1 will be further described while showing an embodiment of the display apparatus of the present invention. The display apparatus can synthesize and display a synthetic stereographic image from a plurality of image files as well as being capable of displaying a stereographic image by referring to a single image file.

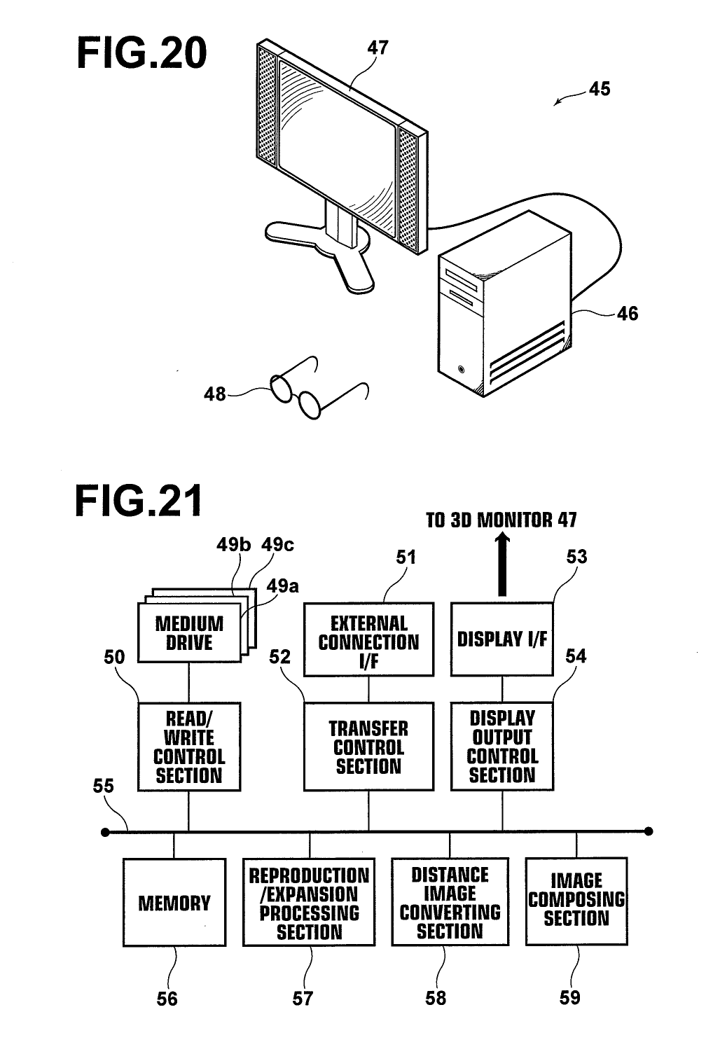

FIG. 20 shows the schematic construction of the stereographic image display apparatus. As shown in FIG. 20, the stereographic image display apparatus 45 comprises a display control system 46, a stereographic display monitor 47, and polarizing glasses 48. When a pair of parallax images, one for the left eye and the other for the right eye, are supplied from the display control system 46, the stereographic display monitor 47 outputs a pair of images different in the direction of polarization simultaneously to one screen. The polarizing glasses 48 are glasses in which a pair of polarizing filters are disposed instead of lenses and the filtering characteristics of the polarizing filters conforms to the directions of polarization by the stereographic display monitor 47. With this structure, when viewing the stereographic display monitor 47 wearing the polarizing glasses 48, the left eye recognizes only the image for the left eye and the right eye recognizes only the image for the right eye.

FIG. 21 shows the display control system 46. The display apparatus is provided with a plurality of medium drives 49a to 49c for driving a recording medium such as a DVD (digital versatile disk) and a memory card, a read/write control section 50 for controlling the read-out and the write-in from and to the recording medium set to the medium drives 49a to 49c, an external connection interface 51 for connecting a cable, a transfer control section 52 for controlling transfer of the image file by way of the external connection interface 51, a memory 56 which stores obtained image file or other data during the course of processing, a display interface 53 for connecting with the stereographic display monitor 47, and display output control section 54 for controlling the display output by way of the display interface 53. The read/write control section 50, transfer control section 52, display output control section 54 and the memory 56 are connected to a system bus 55.

Further, a reproduction/expansion processing section 57, a distance image converting section 58 and an image composing section 59 are connected to the system bus 55. The reproduction/expansion processing section 57 obtains, from an image file which is obtained by the read/write control section 50 or the transfer control section 52 and has been stored in a memory 56, YCC data recorded in the image file in a compressed state. Then the reproduction/expansion processing section 57 expands the YCC data to a state before compression, further carries out YCC-RGB conversion, and stores a pair of parallax images obtained by the conversion again in the memory 56.

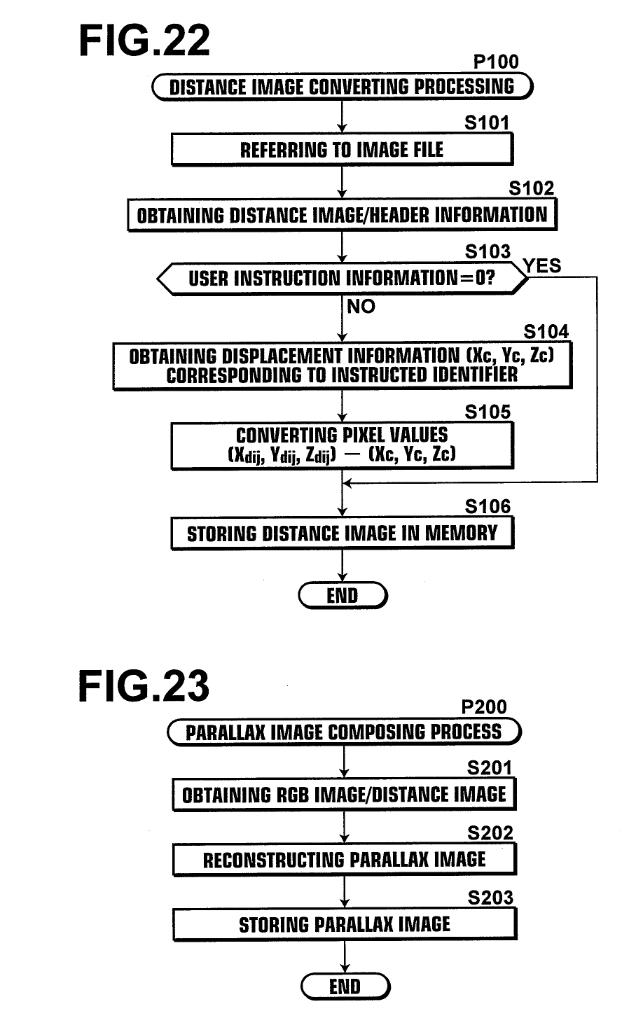

The distance image converting section 58 executes a process P100 represented by a flowchart shown in FIG. 22. That is, the distance image converting section 58 refers to the image file in the memory and confirms whether the header of the file has the areas h1 to h9 shown in FIG. 9 (step S101). If the image file has a different structure, the following steps are not executed. If the image file has the areas h1 to h9, the distance image D and the information stored in the areas h1 to h9 of the file header H are obtained (step S102). Then, it is determined whether the user has specified the universal coordinate system, by determining whether “0” has been set in the area h9 of the file header H (step S103). If a value other than 0 has been set in the area h9 as the identifier, the displacement information linked with the identifier is obtained from the area h9 of the file header H (step S104). The coordinate values obtained as the displacement information are represented by (xc, yc, zc), here.

Then, the distance image converting section 58 converts the distance image in the inherent coordinate system to the distance image in the universal coordinate system specified by the user (step S105). Specifically, coordinate values (xc, yc, zc) indicated by the displacement information are subtracted from values (xdij, ydij, zdij) of each of the pixels forming the distance image, wherein i and j respectively show the vertical and transverse positions of the pixel. Step S105 is executed on all of the pixels forming the distance image. The distance image after the conversion is again stored in the memory 56 (step S106). When the value of the user specified information is “0” in step S103, the distance image as it is obtained in step S102 is stored in the memory 56 without conversion of the distance image (step S106).

FIG. 23 is a flowchart showing the processing executed by the image composing section 59. The image composing section 59 obtains from the memory 56 an image (RGB data) stored by the reproduction/expansion processing section 57 and the distance image after conversion which the distance image converting section 58 has stored (step S201). Then the image composing section 59 reconstructs the parallax images for the right and left eyes by the use of obtained image (RGB data) and the distance image after conversion (step S202). The reconstructed parallax images are stored in the memory 56 (step S203). The display output control section 54 outputs the parallax images stored in the memory 56 at this time to the stereographic display monitor 47.

### [Generation and Display of Synthetic Image]

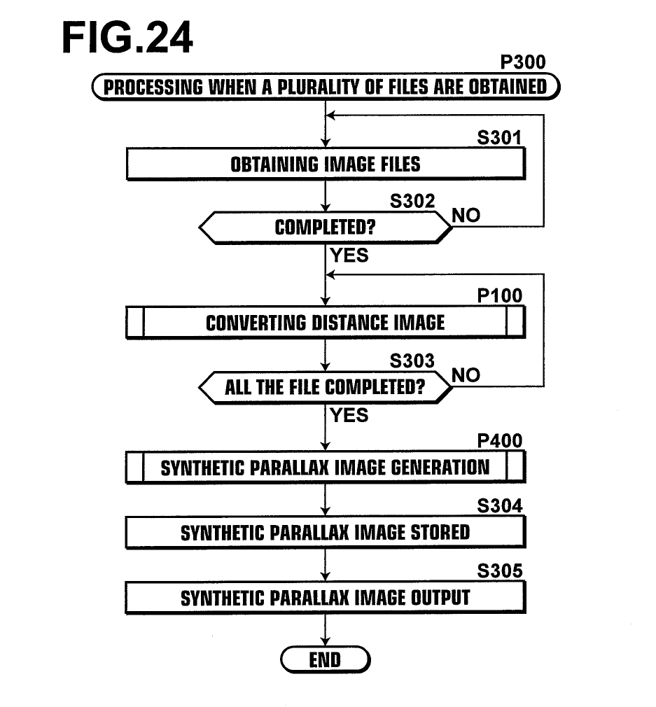

The above description is for the control processing of display of a simple image file. Display control processes when a plurality of image files are taken in will be described with reference to FIG. 24, hereinbelow. When the user carries out an operation to continuously obtain the image files through the operation section (not shown), the read/write control section 50, and/or the transfer control section 52 continuously executes obtainment of the image files according to the operation of the user until the input representing completion of the obtainment is input by the user (steps S301 and S302). The image files obtained by this operation are all stored in the memory 56. The distance image converting section 58 repeatedly executes the distance image conversion process P100 described above with reference to FIG. 22 for all of the image files stored in the memory 56 (step S303).

The image composing section 59 executes a synthetic parallax image generation process P400 on the plurality of the image files stored in the memory 56 and stores a file of the generated synthetic parallax image in the memory 56 (step S304). The synthetic parallax image file stored in the memory 56 is subsequently read out from the memory 56 by the display output control section 54 and output to the stereographic display monitor 47. Further, the synthetic parallax image file stored in the memory 56 can be stored in a recording medium such as a memory card by way of the read/write control section 50, or can be transferred to other systems by way of the transfer control section 52 (step S305).

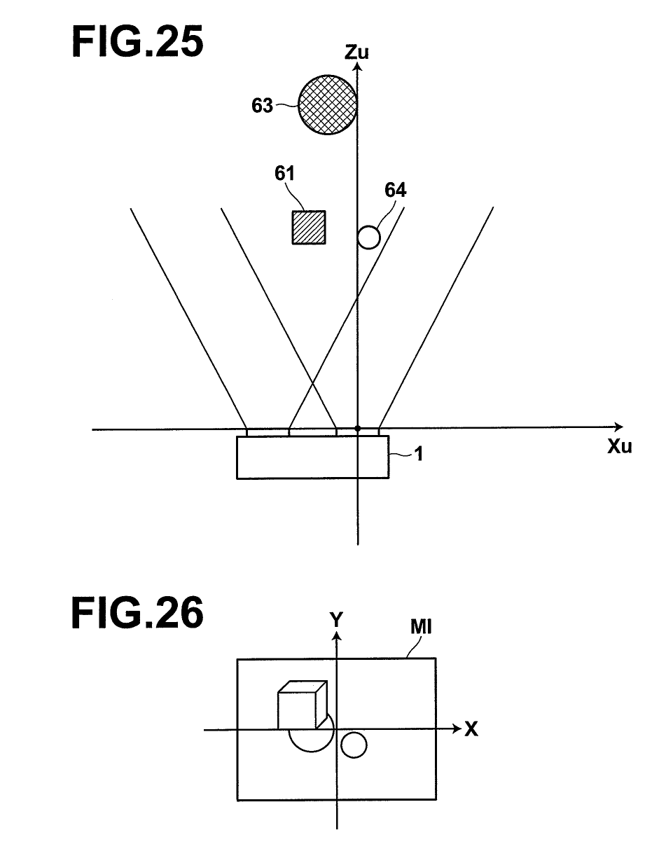

The synthetic parallax image generation process P400 will be further described hereinbelow, with reference to a case in which a pair of image files are synthesized into a synthetic parallax image as an example. FIG. 25 is a view showing the relationship among the camera, photography space and the universal coordinate system when a first image file (to be referred to as “the main image file”, hereinbelow) to be synthesized is obtained. As shown in FIG. 25, the main image file is assumed to be obtained by photographing a photography space, in which objects 61, 63 and 64 are disposed, with a stereo camera 1 in a relatively wide angle of view. FIG. 26 shows an example of a display when the parallax images obtained by this photography are output to the monitor.

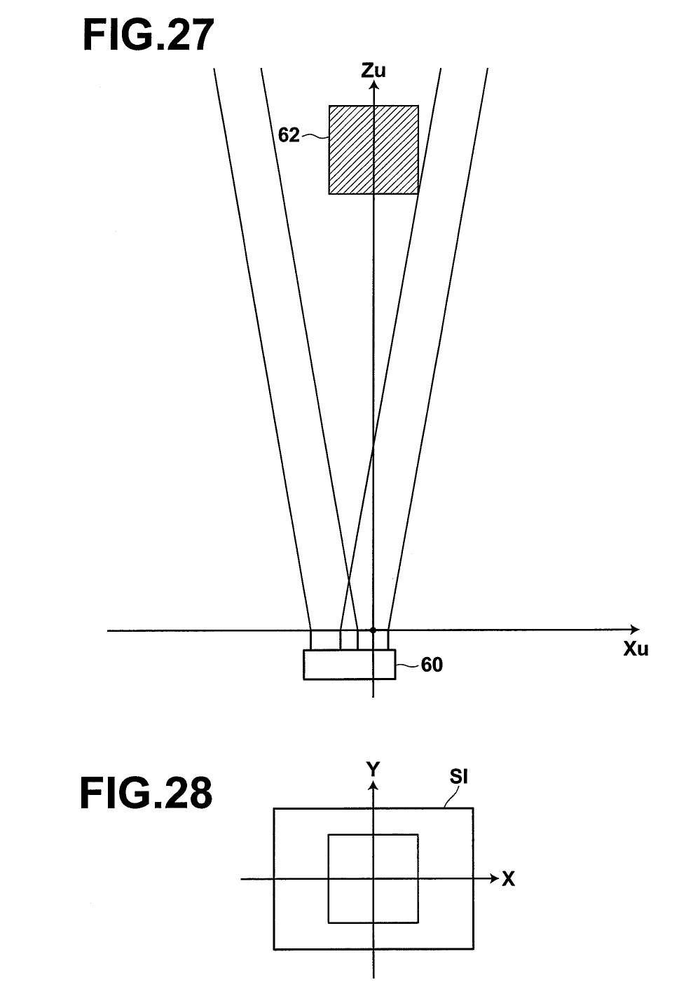

FIG. 27 is a view showing the relationship among the camera, photography space and the universal coordinate system when a second image file (to be referred to as “the sub-image file”, hereinbelow) to be synthesized is obtained. As shown in FIG. 27, the sub-image file is assumed to be obtained by photographing a photography space, in which an object 62 is disposed, with a stereo camera 60 in an angle of view narrower than in the photographing by the stereo camera 1. The stereo camera 60 is a camera which outputs an image file of a format described above referring to FIG. 8 or 9, as the stereo camera 1. FIG. 28 shows an example of a display when the parallax images obtained by this photography are output to the monitor.

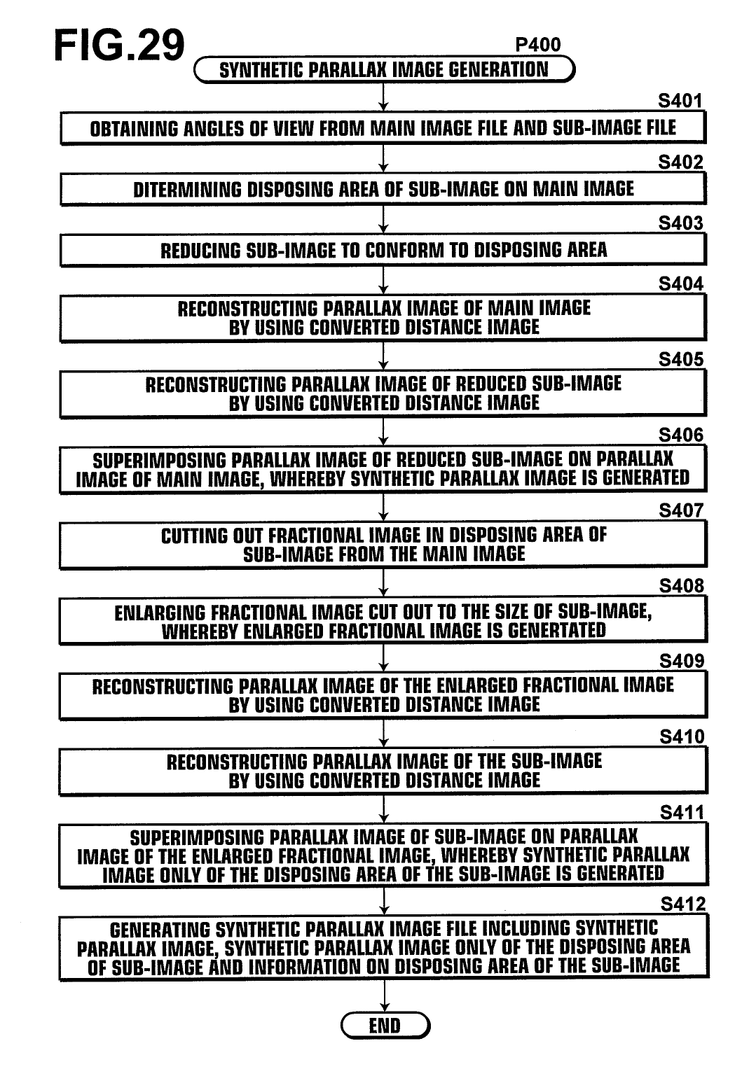

FIG. 29 is a flow chart showing the synthetic parallax image generation process P400. The image composing section 59 first reads in the values of the angles of view αh and αv in the horizontal and vertical directions of the main image file and the values of the angles of view βh and βv in the horizontal and vertical directions of the sub-image file (step S401).

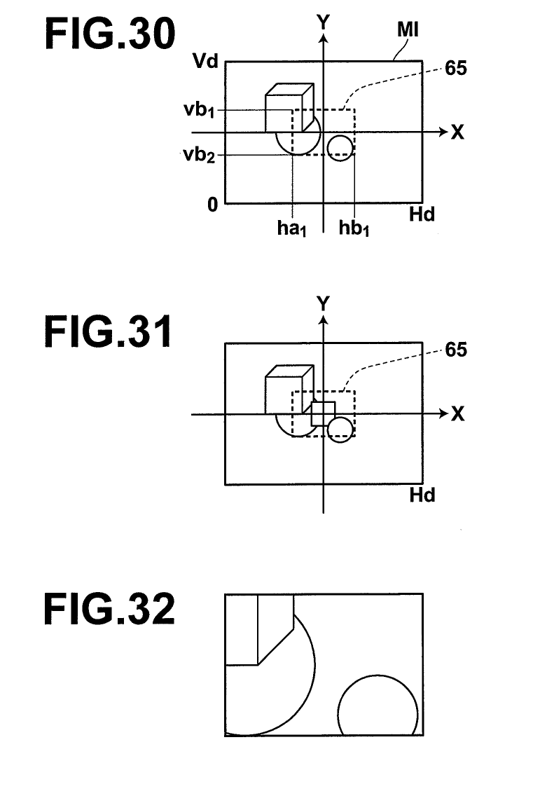

Then, the image composing section 59 calculates the disposing area on the main image M1 of the sub-image S1 when the synthesis is carried out according to the following formula (1) by the use of the values of the angle of view (step S402). In the following formula (1), Hd represents the number of pixels in the horizontal direction of the main image M1 and Vd represents the number of pixels in the vertical direction of the main image M1. Further, the disposing area of the sub-image S1 is obtained as the range ha1 to hb1 in the horizontal direction and as the range va1 to vb1 in the vertical direction when the lower left apex of the main image is taken as (0, 0) and the upper right apex of the main image is taken as (Hd, Vd). The relationship among Hd, Vd, ha1, hb1, va1 and vb1 and the disposing area 65 identified by the same are shown in FIG. 30 by way of example.

ha1=(Hd/2)−(Hd/2)×(arctan βh/arctan αh)

hb1=(Hd/2)+(Hd/2)×(arctan βh/arctan αh)

va1=(Vd/2)−(Vd/2)×(arctan βv/arctan αv)

vb1=(Vd/2)+(Vd/2)×(arctan βv/arctan αv) (1)

The image composing section 59 reduces the size of the parallax image in the sub-image file to match that of the disposing area 65 obtained in step S402 (step S403). Then the image composing section 59 reconstructs the parallax image for the main image by the use of the distance image after conversion (step S404). Although the image composing section 59 reconstructs the parallax image for the sub-image by the use of the distance image after conversion also, this process is carried out on the image reduced in size in step S403, and not on the image recorded in the sub-image file (step S405). Then, the image composing section 59 generates the synthetic parallax image by superposing the reduced size sub-image parallax image composed in step S405 on the main image parallax image reconstructed in step S404 (step S406). FIG. 31 shows an example of a display when the synthetic parallax image generated in this processing is output to the monitor.

The synthetic parallax image is completed by the process described above. The image composing section 59 in this embodiment further generates an enlarged synthetic parallax image of only the disposing area 65. Generation of the enlarged synthetic parallax image will be described hereinbelow.

The image composing section 59 cuts out from the parallax image in the main image file, that is, from the parallax image before synthesis, a part corresponding to the disposing area of the sub-image. The part of the parallax image which has been cut out will be referred to as “the fractional image” hereinbelow. Then, the cut out fractional image is enlarged to a size equal to the size of the sub-image before reduction (step S408). The enlarged parallax image will be referred to as “the enlarged fractional image” hereinbelow. The image composing section 59 then reconstructs the parallax images of the fractional image by the use of the distance image after conversion (step S409). FIG. 32 shows an example of a display when parallax images of the reconstructed enlarged fractional image are output to the monitor.

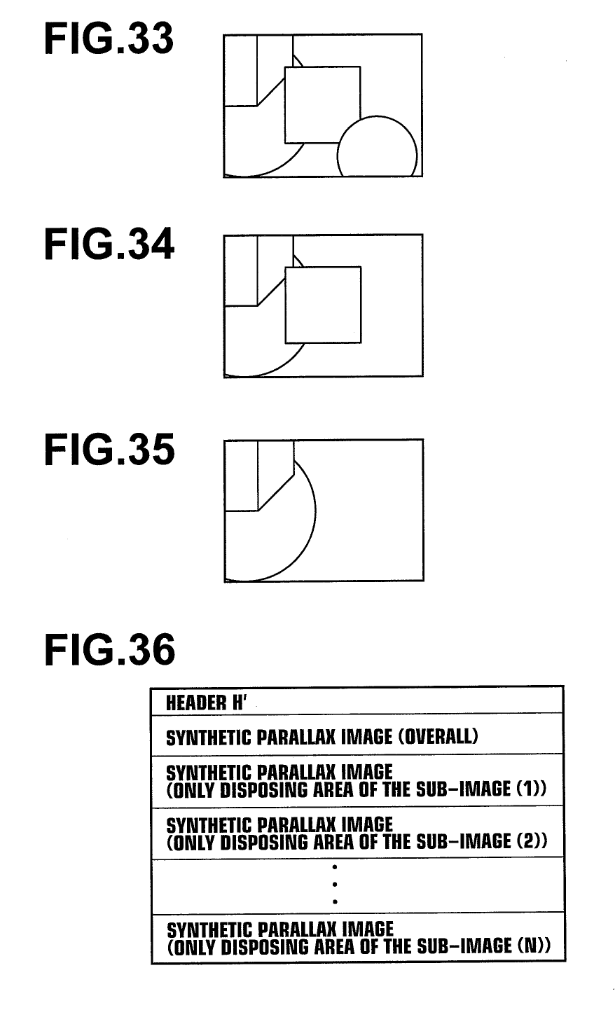

Further, the parallax images of the sub-image are also reconstructed by the use of the distance image after conversion (step S410). Then, the image composing section 59 superposes the sub-image parallax image composed in step S410 on the enlarged fractional image parallax image reconstructed in step S409, thereby generating the synthetic parallax images of the sub-image corresponding to the disposing area only (step S411). FIG. 33 shows an example of a display when the synthetic parallax images of the sub-image corresponding to the disposing area only are output to the monitor. Then, the image composing section 59 generates a synthetic parallax image file including the synthetic parallax image generated in step S406, the synthetic parallax images of the sub-image corresponding to the disposing area only generated in step S411, and information on the disposing area obtained in step S402 (step S412).

When three or more image files are to be synthesized, it is preferred that the image having the largest angle of view of the image files be designated as the main image while the others are designated as the sub-images on the basis of the information on the angle of view read in step S401, then to perform the processes thereafter. In this case, the process related to the sub-image is executed for every sub-image. If the synthesis is carried out with the angle of view of the sub-images being larger than that of the main image, it is conceivable to carry out the synthesis after the parts beyond the angle of view of the main image is removed from the sub-images.

In the above example, that the relative position is accurately reproduced is preferred and the synthetic parallax images shown in FIGS. 31 and 33 are both reproduced faithfully to the distance image after conversion. In contrast, a form where ease of viewing is preferred to accuracy is conceivable. For example, the user would require the synthetic parallax image shown in FIG. 33 when he or she wants to better see the sub-image. Accordingly, ease of viewing may be preferred to accurate reproduction of the sub-image when displaying the synthetic parallax image shown in FIG. 33. In accordance with such a concept, a special display such as shown in FIG. 34 is preferred to the display shown in FIG. 33. That is, when there is an object in the main image that conceals an object included in the sub-image, the object in the main image that conceals the object included in the sub-image is not displayed.

When the special display is displayed, the pixels having values representing positions in front of the object included in the sub-image are searched for before the parallax images of the partially enlarged image are reconstructed in step S409, and the values of the pixels are substituted by those representing infinity. Thereby, since it becomes as if nothing is disposed in the range of substituted pixels, the parallax images of the partially enlarged image reconstructed in step S409 are as shown in FIG. 35. That is, the object in the main image that conceals the object included in the sub-image is not displayed. The processes thereafter are the same as the processing in steps S410 to S412 described above.

The format of the synthetic parallax image file will be described, hereinbelow. As shown in FIG. 36, the synthetic parallax image file comprises a file header H′, synthetic parallax images of the overall image generated in step S406 above and synthetic parallax images of only the disposing area of the sub-image generated in step S411 above. When there are a plurality of image files, a plurality of synthetic parallax images of the disposing area only of the sub-image are recorded in the file, as shown in FIG. 36.

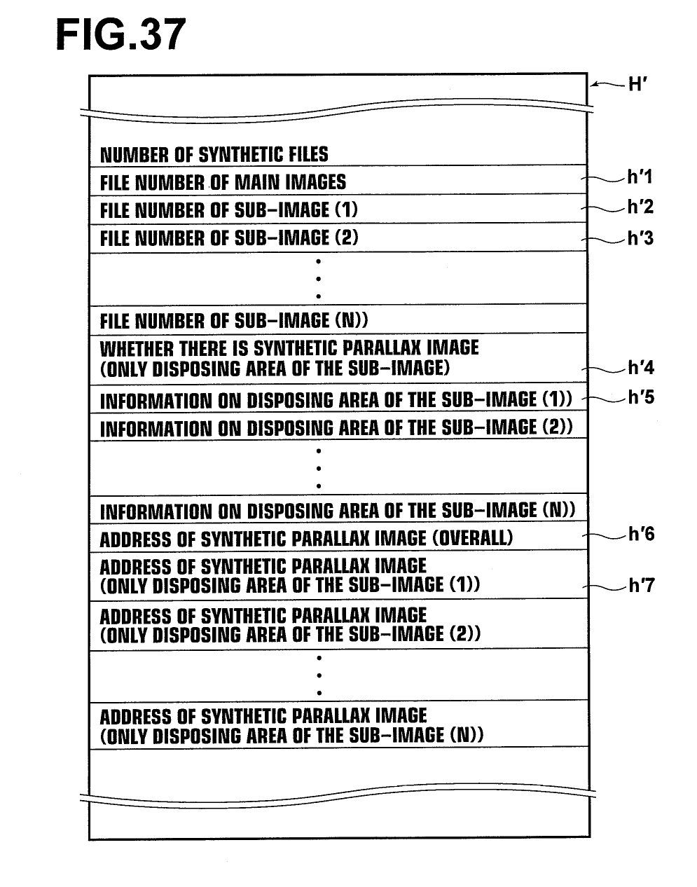

As shown in FIG. 37, the file header H′ is provided with an area h′1 for storing the number of image files to be synthesized, an area h′2 for storing the file numbers of main image files in the memory, an area h′3 for storing the file numbers of sub-image files in the memory, an area h′4 for storing data representing whether there are synthetic parallax images of a sub-image disposing area, an area h′5 for storing the sub-image disposing area, an area h′6 for storing the address of the synthetic parallax images and areas h′7 for storing the addresses of synthetic parallax images of only the disposing area of the sub-image. The areas h′3, h′5 and h′7 are provided with areas of the same in number as those of the sub-images. In addition to the above areas, an area for storing information on the link to the original image file employed in the synthesis may be provided.

In the area h′1, the value representing the number of files is set. Each file number set in the area h′2 or h′3 is an identifier for designating the file and may be a symbol including an alphabetical letter or the like. A value of “1” is set in the area h′4 when the file includes synthetic parallax images of only the disposing area of the sub-image, and a value of “0” is set otherwise. When the processes of steps S407 to S411 are abbreviated in the flowchart shown in FIG. 29, a value of “0” is set in the area h′4. The values of ha1, hb1, va1 and vb1 obtained in step S402 are stored in the area h′5. The addresses representing the positions in which each synthetic parallax image has been stored are written in the areas h′6 and h′7. Here, the “address” here, for instance, an amount of offset from the top of the file to each synthetic parallax image shown in FIG. 36.

As can be understood from the above description, the image composing section 59 carries out the synthesis of the images by the use of the distance image after conversion by the distance image converting section 58. That is, the image composing section 59 synthesizes the parallax image on the universal coordinate system. Accordingly, when a universal coordinate system is the same in the main image file and the sub-image file is designated in the file header, the problems inherent to the conventional technique do not arise, whereby the same result can be obtained irrespective of whether the image files to be synthesized are generated by the same apparatus or different apparatuses. Especially, the conventional technique in which the offset of the positions can take place, cannot yield stabilized results in a complicated synthesis followed by enlargement/reduction as in the above example. In this embodiment since various image processes can be applied without paying attention to the offset in the positions of the coordinate systems, even a more complicated synthesis can yield stabilized results.

Further, in this embodiment, the image composing section 59 does not carry out the synthesis each time the display is carried out but the parallax images obtained by the synthesis and the information obtained in the course of synthesis are stored in an image file together with each other. Accordingly, when the display of the same synthetic parallax images subsequently becomes necessary, the synthetic parallax image in the image file has only to be reproduced on the monitor and the processing time can be largely shortened. Further, since they are stored in the form of an image file, synthesis and display can be shared between different apparatuses. By causing a different apparatus to execute the synthesis, the circuit forming the display apparatus can be simplified, which leads to reduction in size and cost of the display apparatus.

### [Modifications]

Although in the above embodiment, the file header H of the image file 31 is provided with a plurality of areas for storing the displacement information of the universal coordinate system and with the user specified information, a method in which only one area for storing the displacement information of the universal coordinate system is provided and only one item of user specified information is recorded in the file header is conceivable.

Although in the above embodiment, the origin of each universal coordinate system is on a characteristic point on a member that constitutes the camera, it is conceivable to receive input from the user specifying an arbitrary point in the photography space and to designate the point as the origin of the universal coordinate system. That is, the displacement information need not be stored in the memory upon production of the camera, but may be set by the user upon generation of the image file. Thereby, for instance, when the camera cannot be set in the position of the reference mark and has to be set slightly rearward, the displacement information on the basis of the origin on the reference mark can be corrected by the user to conform to the camera position.

Although in the above embodiment, in the synthetic parallax image file, the enlarged synthetic parallax image where only the disposing area of the sub-image is synthesized is also recorded in addition to the normal synthetic parallax images, the display control apparatus may output the synthetic parallax image not including the enlarged synthetic parallax image, or may synthesize the images every time the image is displayed without generating the synthetic parallax image file.

What is claimed is;

1. An apparatus for generating a file in which three-dimensional information is recorded, comprising:
a three-dimensional information generating means for generating three-dimensional information representing each point obtained by an imaging system, as information of an inherent coordinate system inherent to the imaging system;
a displacement information storage means for storing displacement information that represents displacement of an origin of an universal coordinate system from an origin of the inherent coordinate system, as information of the universal coordinate system common to a plurality of imaging systems; and
a file generating means for generating a file of a predetermined format including three-dimensional information generated by the three-dimensional information generating means and the displacement information stored by the displacement information storage means.

2. An apparatus as defined in claim 1, wherein the displacement information storage means stores a plurality of pieces of displacement information for a plurality of universal coordinate system respectively.

3. An apparatus as defined in claim 2, wherein the file generating means generates a file of a predetermined format including three-dimensional information generated by the three-dimensional information generating means, a plurality of pieces of displacement information stored by the displacement information storage means for each of the universal coordinate system, and an identifier indicating one of a plurality of pieces of the displacement information designated by a user's operation.

4. An apparatus as defined in claim 1, wherein the file generating means generates a file further including information representing a type of the universal coordinate system.

5. An apparatus as defined in claim 1, wherein a type of the universal coordinate system is an orthogonal coordinate system or a polar coordinate system.

6. An apparatus as defined in claim 1, wherein the origin of the universal coordinate system is at a predetermined characteristic point on a member that constitutes the imaging system or a member formed integrally with the imaging system.

7. An apparatus as defined in claim 6, wherein one of the characteristic points on the member is a mark provided at a position which can be recognized from the outer appearance of a member which can be recognized from the outer appearance of the imaging system.

8. An apparatus as defined in claim 7, wherein the member which can be recognized from the outer appearance of the imaging system is a monitor formed integrally with the imaging system, and the mark is displayed on the monitor.

9. An apparatus as defined in claim 1 further comprising a displacement setting means which resets the displacement information stored by the displacement information storage means on the basis of the focal length of the lens which the imaging system has.

10. An apparatus as defined in claim 1, wherein the three-dimensional information generating means generates a distance image as the three-dimensional information, which includes the positional coordinates of the points obtained by the imaging system in the inherent coordinate system, as the values of pixels corresponding to the respective points.

11. A method for generating a file in which three-dimensional information is recorded, comprising the steps of:
storing imaging system displacement information that represents the displacement of an origin of an universal coordinate system from an origin of an inherent coordinate system as information of the universal coordinate system, wherein the inherent coordinate system is inherent to an imaging system, and the universal coordinate system is common to a plurality of imaging systems;
generating three-dimensional information representing each point obtained by the imaging system by the inherent coordinate system; and
generating a file of a predetermined format including the three-dimensional information and the displacement information.

12. An apparatus for controlling display of a stereographic image, comprising:
file obtaining means which obtains an image file including an image of a photography space, three-dimensional information representing the photography space in a inherent coordinate system which is inherent to an imaging system and displacement information representing the displacement of the origin of an universal coordinate system common to a plurality of imaging systems from the origin of the inherent coordinate system;
a three-dimensional information converting means which displaces the three-dimensional information in the image file obtained by the file obtaining means according to the displacement information in the image file, thereby converting three-dimensional information represented by the inherent coordinate system to that represented by the universal coordinate system;
an image composing means which composes a parallax image for display by correcting an image in the image file obtained by the file obtaining means based on the converted three-dimensional information; and
an output control means which outputs the parallax image for display composed by the image composing means to a display device.

13. An apparatus as defined in claim 12, wherein
the image composing means further composes a synthetic parallax image by synthesizing a plurality of sets of parallax images for display composed by the image composing means, and
the output control means outputs the composed synthetic parallax images to a display device.

14. A display controlling method for controlling display of a three-dimensional image, comprising the steps of:
obtaining an image file including an image where a photography space is taken, three-dimensional information representing the photography space by the inherent coordinate system inherent to the imaging system, and displacement information representing displacement of an origin of a universal coordinate system common to a plurality of coordinate systems from an origin of the inherent coordinate system is obtained;
converting three-dimensional information represented by the inherent coordinate system to that represented by the universal coordinate system by displacing the three-dimensional information in the image file on the basis of the displacement information in the image file;
composing a parallax image for display by correcting the image in the image file on the basis of the converted three-dimensional information; and
outputting the composed parallax image to a display device.
